(19) United States
(12) Patent Application Publication
(10) Pub. No.: US 2012/0320421 A1
(43) Pub. Date: Dec. 20, 2012

(54) DIGITAL IMAGE REPRODUCTION APPARATUS FOR PRINTING A DIGITAL DATA FILE AND A METHOD FOR PRINTING A DIGITAL DATA FILE

(76) Inventors: Lambertus A.H. VAN VONDEREN, Venray (NL); Anita C. Morskate, Tegelen (NL); Jacob J.D. De Jong, Venlo (NL)

(21) Appl. No.: 13/593,580

(22) Filed: Aug. 24, 2012

Related U.S. Application Data
(63) Continuation of application No. PCT/EP2011/051962, filed on Feb. 10, 2011.

(30) Foreign Application Priority Data
Feb. 26, 2010 (EP) 10154919.4

(51) Int. Cl. G06K 15/02

(52) U.S. Cl. 358/1.15

(57) ABSTRACT

A digital image reproduction apparatus includes a receiving device configured to receive a print job including at least one digital data file, a first storing device configured to store the print job, a local user interface enabling an operator to make settings of the print job, a managing device configured to manage settings of the print job, a second storing device configured to store the settings of the print job related to the storage of the print job, and a locking device settable via the user interface and configured to lock at least one setting of the print job to achieve unchangeability of the at least one setting. A method for printing a digital data file on a digital image reproduction apparatus includes locking at least one setting of the digital data file by the operator via the local user interface so as to prevent any inadvertent change thereof.

### CROSS-REFERENCE TO RELATED APPLICATIONS

This application is a Continuation of International Application No. PCT/EP2011/051962, filed on Feb. 10, 2011, and for which priority is claimed under 35 U.S.C. §120, and which claims priority under 35 U.S.C. §119 to Application No. 10154919.4, filed in Europe on Feb. 26, 2010. The entirety of each of the above-identified applications is expressly incorporated herein by reference.

### BACKGROUND OF THE INVENTION

1. Field of the Invention

The present invention relates to a digital image reproduction apparatus comprising a receiving device configured to receive a print job comprising at least one digital data file, a first storing device configured to store the print job, a local user interface enabling an operator to make settings of the print job, a managing device configured to manage settings of the print job and a second storing device configured to store the settings of the print job related to the storage of the print job.

2. Background of the Invention

Reproduction apparatuses of the kind described above are known, e.g., from U.S. Pat. No. 6,545,769. Such apparatuses can be used for copying and scanning documents and printing digital image data files created at a workstation. Normally, the reproduction apparatus is connected with a network comprising at least one workstation. When a digital data file is sent to the reproduction apparatus, it may be scheduled in a queue within the first storing device for further processing or be stored in the first storing device. Such a first storing device may contain storage cells for each user, who has registered himself at the reproduction apparatus and created such a storage cell. On the other hand, such a storage cell may be created by an operator of the apparatus for a customer and is independent from which work station the incoming digital data files have been sent. Per storage cell, the following information is present: a name for the storage cell, a number of documents in the storage cell and a pin code if a protected entrance to the storage cell is desired.

### SUMMARY OF THE INVENTION

The digital image reproduction apparatus comprises a managing device configured to manage settings of the print job. For example, if a print job is sent to the apparatus via a printer driver mechanism, settings may be sent along with the print job to the apparatus. The managing device of the apparatus defines such settings and may store the settings of the print job in the second storing device. The storing of the settings is usually done in such a way that the settings of a print job are related in memory to the first storing device for storing the digital data files of the print job. The settings may be defined per digital data file of the print job. Generally these settings may be changed by a user or an operator of the apparatus via the local user interface, if he wants to change one or more settings before printing the document. The user or operator may want to have a first print, for example a proof print. After making the proof print, the user checks the pages resulting from printing the at least one digital data file. If the proof print is not correct, settings may be changed and a second proof print may be created. This process continues until a proof print is correct. When a proof print is correct, the user may print as many additional prints as he wants by changing the number of copies setting among the settings of the at least one digital data file.

Often, a first print is sent to a customer who has to judge if the first print is correctly printed. Some time may lapse until the answer of the customer, regarding whether or not the first print is correctly printed, is received by the user or operator of the reproduction apparatus. Therefore, printing of additional copies may be much later in time than the first print. The operator or user may therefore leave the at least one digital data file in the first storing device and the settings of the digital data file in the second storing device until the additional copies have been printed. However, by leaving the settings after the first print in the second storing device, the user takes a risk that the settings or at least part of the settings may be changed by someone else or by the user himself, e.g. by accident or inadvertently. This is undesirable, since the original settings or at least part of the original settings of the first print have to be unchanged until the time that the additional prints are to be processed.

Customers are known who use printed jobs to reprint jobs, e.g. when extra sets of documents are needed on customer request or to compensate for damaged sets during finishing. This customer type likes to have more information about printed jobs, e.g. date/time when the job was printed. In this case the setting that is most likely to be changed is the number of copies. The rest of the settings must remain unchanged when the output needs to be exactly similar to the previously produced output.

The object of the present invention is to create a reproduction apparatus which comprises features aimed at guaranteeing that a print of a digital data file is exactly similar to prints of the digital data file printed later in time with respect to a desired part of the settings of the digital data file, which part of the settings need not to be changed.

The object of the present invention can be achieved in a reproduction apparatus according to the preamble, wherein the digital image reproduction apparatus comprises a locking device, settable via the user interface, and configured to lock at least one setting of the print job in order to achieve unchangeability of the at least one setting.

By locking settings of a digital data file by means of the locking device at a suitable moment, the settings of the document cannot be changed any more. Therefore, additional prints are ensured to be exactly the same as an earlier print with respect to the locked settings.

A suitable moment for locking may be before printing the first print or just after printing the first print. In this way, the settings will be locked during the printing of additional prints.

According to an embodiment of the present invention, the locking device also enables unlocking of the at least one setting of the print job in order to achieve changeability of the at least one setting.

The user or operator may unlock locked settings of a print job by means of the locking device, for example, in order to make changes to the locked settings after a first print of a digital data file of the print job. Such changes may be necessary in case the first print is not exactly according to the customer needs. The operator or user may make the changes to the settings of the print job and then lock the settings of the print job again.

In an embodiment of the present invention, for each digital data file in the print job, the locking device sets a flag representing one of statuses locked and unlocked, wherein at least one setting of the digital data file is unchangeable when the status of the digital data file is locked, and at least one setting of the digital data file is changeable when the status of the digital data file is unlocked. The managing device is able to switch the content of the flag from a locked status into an unlocked status and from an unlocked status into a locked status.

In an embodiment of the present invention, the local user interface is suitable to show simultaneously with the at least one selectable digital data file a lock item by activation of which the managing device writes the status locked at the flag corresponding to the at least one selected digital data file. Via the local user interface, the digital image reproduction apparatus enables the user to select at least one data file to be printed and lock the settings of the at least one data file.

In an embodiment of the present invention, after selection of a locked digital data file, the managing device shows via the local user interface, simultaneously with settings of the selected locked digital data file, an unlock item by activation of which the managing device writes the status unlocked at the flag corresponding to the locked digital data file. In this way, the local user interface of the digital image reproduction apparatus enables the user to select one locked digital data file and unlock the settings of the selected file. By prohibiting the user to select more than one digital data file and unlock these data files at the same time, the user needs to deliberately want to unlock a digital data file, so that mistakes can be avoided.

In an embodiment of the present invention, the managing device of the digital image reproduction apparatus is able to maintain a group of job settings which are excluded from locking.

Such a set of unlockable settings may be gathered in a system setting of the digital image reproduction apparatus. Other system settings may, for example, involve settings regarding tuning of the local user interface, workflow settings, selection of a language for the local user interface, setting of banner and trailer pages and offset stacking options.

Before taking any actions on locking, the user wants to determine whether or not a setting of a digital file may be locked at all. If the user determines a group of settings which may not be locked at all, he may want to exclude these settings from locking by the managing device via the lock item. Therefore, these settings may be registered in a system setting at the managing device of the apparatus. This registration will then prohibit each setting from this group to become locked for each digital data file. For example, if a first print is made and additional prints are needed several times, the user does not always want to print the same number of additional prints. Therefore the setting which represents the number of copies may be part of the group of settings excluded from being locked.

In an embodiment of the present invention, system settings of the apparatus are part of the settings of a digital data file.

In order to obtain the same additional prints as an earlier first print of a digital data file, it may not be enough to only lock property settings of the digital data file. Especially, if a time period, lapsed between the first print and the additional copies, is so large that in the meanwhile an operator has changed a system setting of the apparatus, the additional prints may be different from the first print because of the changed system setting. For example, a change of the system setting regarding the presence of banner pages and/or trailer pages will influence the output of a print.

Therefore, system settings of the apparatus at the time of a first print may be part of the settings of the digital data file. These particular system settings being part of the settings of the digital data file may also be locked. Just before printing additional prints, the embedded system settings, which are locked for the digital data file, may be used by the system and/or the managing device to assure that the system settings of the apparatus will be adapted to their values at the time of the first print. In this manner, it is assured that additional prints printed by the apparatus are exactly the same with respect to these locked system settings.

In an embodiment of the present invention, the managing device, when storing a digital data file in the first storing device, writes one of the statuses at the flag corresponding to the digital data file, which status is indicated by a digital item included in the digital data file. When a digital data file is sent to the apparatus, it may already contain, for example in an additional job ticket, property settings which have to be saved for a first print and additional prints later on. In such a case, it would be advantageous for the user that these properties may be locked automatically, when the digital data file is stored in the first storing device. This may be achieved, e.g. by including a digital item in the digital data file, which triggers an automatic locking of these properties by the apparatus. As soon as the digital data file is stored in the first storing device, these settings of the digital data file are locked with respect to the corresponding properties in the job ticket. This is advantageous, because immediately after storing the digital data file, and thus also in a time period before a first print of the digital data file, the digital data file settings are locked and unchangeable.

According to another embodiment of the present invention, the first and second storing devices are the same storing device with sufficient capacity to store both the digital data file and the settings of the digital data file. This is advantageous from an economic perspective, and a less complex storing device can be achieved.

In an embodiment of the present invention, the local user interface is enabled to show a digital data file accompanied by a digital item indicating whether at least one setting of the digital data file is locked.

This is advantageous, since the user can see in a list of digital data files, if settings of a digital data file are locked. Moreover, before opening such a marked digital data file for displaying settings of the digital data file, the user knows that settings of the digital data file are locked.

The present invention further provides a method for printing a digital data file on a digital image reproduction apparatus comprising a local user interface, the method comprising the steps of receiving a digital data file by the digital image reproduction apparatus, storing the digital data at the digital image reproduction apparatus, defining settings of the digital data file by an operator via the local user interface, storing the defined settings in relation to the stored digital data file by an operator via the local user interface, printing the digital data file by the digital image reproduction apparatus, and locking at least one setting of the digital data file by the operator via the local user interface so as to prevent any inadvertent change thereof.

In an embodiment of the method of the present invention, the method comprises the steps of unlocking the settings of the digital data file by the operator via the local user interface and changing the settings of the digital data file by the operator via the local user interface. This may take place before the step of printing the digital data file or after the step of printing the digital data file. When the settings are changed, the settings may be locked again and additional prints may be printed by the apparatus.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 shows a network system which comprises a reproduction apparatus;

FIG. 2 shows the reproduction apparatus in which the present invention may be installed;

FIG. 3 shows a schematic diagram of a first screen of the user interface unit of the reproduction apparatus;

FIG. 4 shows a schematic diagram of a plurality of document boxes;

FIG. 5 shows a schematic diagram of a plurality of digital data files in a selected document box;

FIG. 6 shows a schematic diagram of a plurality of settings of a selected digital data file;

FIG. 7 shows a schematic diagram of a plurality of locked settings of a selected digital data file;

FIG. 8 shows a schematic diagram of a plurality of digital data files in a selected document box, from which plurality of digital data file one file comprises locked settings; and

FIG. 9 shows a flow diagram of the method to be applied by the reproduction apparatus according to the invention.

### DETAILED DESCRIPTION OF THE PREFERRED EMBODIMENTS

The present invention will now be described with reference to the accompanying drawings, wherein the same or similar elements are identified with the same reference numeral.

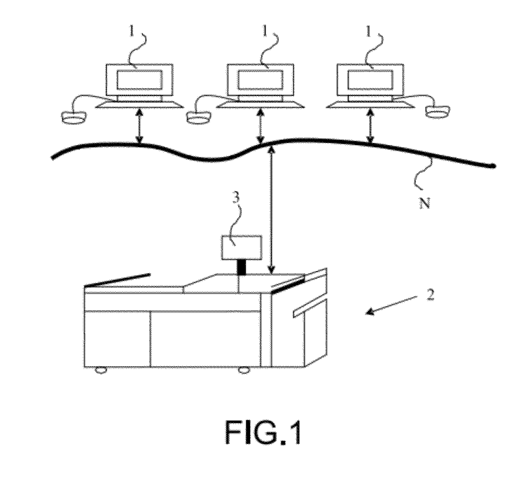

FIG. 1 shows a system comprising workstations 1 connected to a local network N. A digital image reproduction apparatus 2 according to an embodiment of the invention is particularly suited for use in this kind of environment, where the digital image reproduction apparatus 2 is available for a user working with one of the workstations 1 and intending to print a set of documents and is also available for a user who just wants to copy or to scan a document. The digital image reproduction apparatus 2 is connected to the network N and comprises a receiving device configured to receive print jobs from the workstations 1. The network N may be wireless. The digital image reproduction apparatus 2 may comprise a scan module for scanning a document.

The digital image reproduction apparatus 2 comprises a user interface 3, which will be elucidated further on.

In an embodiment, each of the workstations 1 is a personal computer provided with a processor unit, a display unit, e.g. a touch screen or any other input device in order to let a user, who is logged in on a workstation, submit a digital data file to the digital image reproduction apparatus 2.

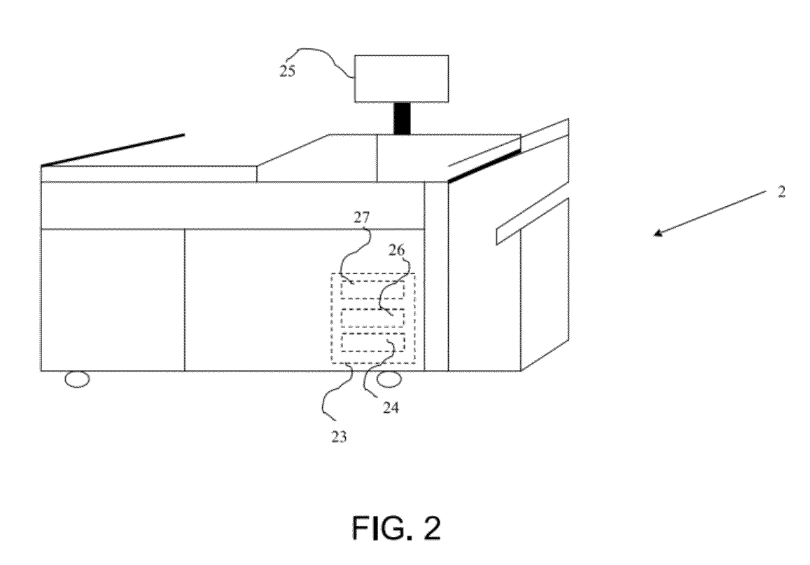

In an embodiment, shown in FIG. 2, the digital image reproduction apparatus 2 comprises a user interface 25 comprising a display and an input device configured to display screens containing information for the user standing at the reproduction apparatus 2 and a managing device 23 comprising a first storing device 24 such as a part of a hard disk configured to store a print job incoming from the network or from a scan unit connected to or integrated in the digital image reproduction apparatus 2 (not shown), a second storing device 27, which may be another part of the same hard disk, configured to store settings of a print job and a locking device 26 configured to store a flag per print job indicating that the print job is locked or unlocked. The flag may be a number of bits, for example 0 for an unlocked print job and 1 for locked print job.

The digital image reproduction apparatus 2 is also connected to a display and an input device for enabling a user to enter commands, for example, in order to execute printing of digital documents. The display and the input device may be combined and realized by a touch screen 25. Hereinafter, is assumed that the display and input device are realized by a touch screen, however, other implementations of the display and input device are not excluded. A cancel button and a start button may be part of an initial window on the touch screen 25 (not shown), but may also be implemented at another place at the reproduction apparatus 25. The first storing device 24 is suitable to contain a plurality of jobs, which have been submitted to the digital image reproduction apparatus 2 via the local network N (FIG. 1). Part of the plurality of jobs may be displayed on the touch screen 25. A user may select a job on the touch screen 25 he wants to process the job. The control of the digital image reproduction apparatus, including the touch screen 25, is done by the managing device 23. The first and second storing devices 24, 27 and even the locking device 26, may be combined into one single storing device.

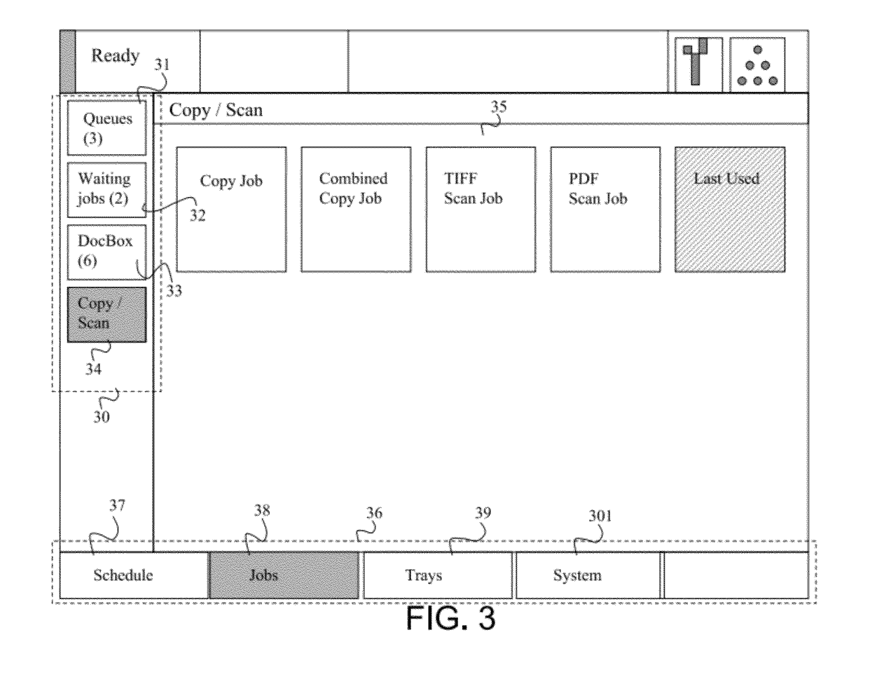

In an embodiment, a first window on the touch screen 25, shown in FIG. 3, comprises a first panel 36, a second panel 30 and a third panel 35.

The first panel 36 comprises a schedule button item 37 for showing a schedule of jobs which are scheduled, a jobs button item 38 for showing jobs directly, a trays button item 39 for showing the trays and properties for each of the trays, and a system button item 301 for showing system settings of the reproduction apparatus 2. Among the system settings approachable via system button item 301, a particular system setting may be dedicated in order to group the settings of a digital data file, which will not be allowed to be locked. By changing this particular system setting, the group of lockable settings of each digital data file can be changed.

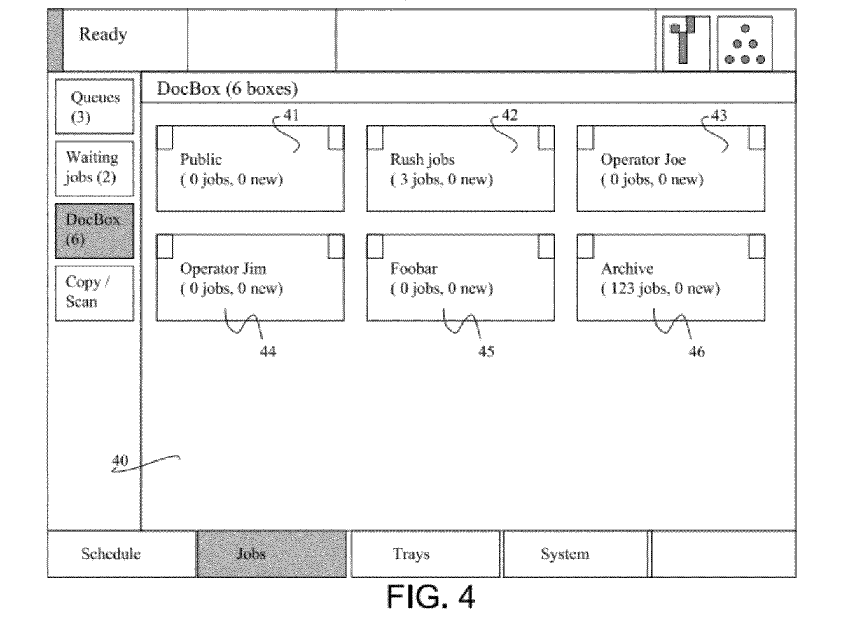

The second panel 30 comprises a first button item 31, a second button item 32, a third button item 33 and a fourth button item 34. The first button item 31 may be activated in order to show the user a number of queues in which jobs are placed. A queue for printed jobs, a queue for scheduled jobs and a queue for scan jobs may be established. The second button item 32 may be activated in order to show waiting jobs, which have not yet been scheduled to be printed. The third button item 33 may be activated in order to show a number of document boxes, which will be described in FIG. 4. The fourth button 34 may be activated in order to enable the user to perform a copy job or a scan job. The fourth button 34 is selected here, indicated by the grey button.

The third panel 35 shows possible features for a copy job or a scan job, for example a copy job, a combined copy job, a TIFF scan job, a PDF scan job and a Last Used job.

The Last Used job option may be grayed out as shown in FIG. 3 because of non-availability.

When selecting the third button item 33, at least one document box is shown in a second window 40 as shown in FIG. 4.

In an embodiment, the plurality of jobs submitted to the managing device 23 of the reproduction apparatus 2 (see FIG. 2) are grouped in document boxes 41-46. Each document box 41-46 is a part of the first and/or second storing device and may comprise at least one data file. The window 40 on the touch screen 25 may be an overview of the document boxes 41-46. At the overview of document boxes 41-46 a document box may be selected. After selection of a document box, the managing device 23 opens a third window 50 on the touch screen 25 on top of, beside or instead of the second window 40 in order to show all digital data files present in the selected document box.

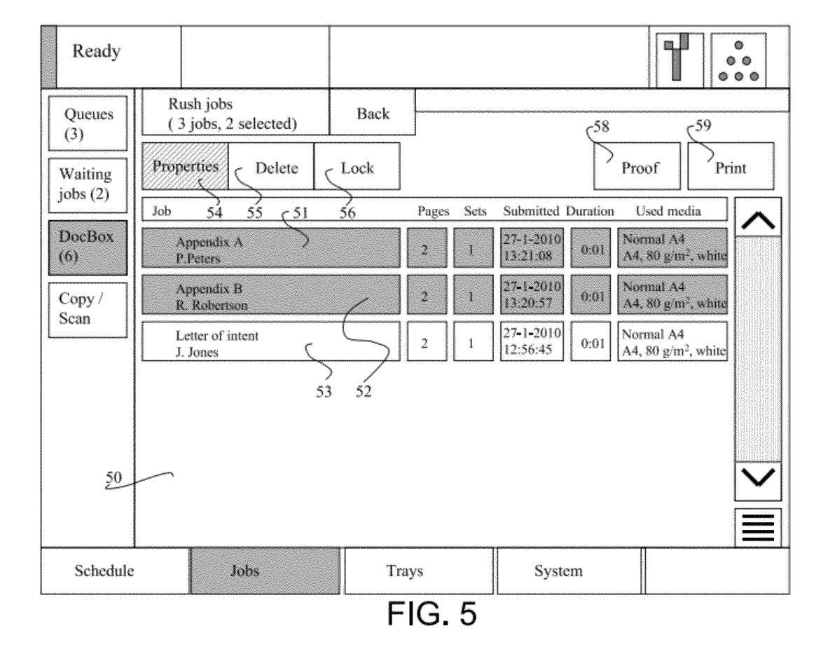

Such a third window 50 is shown in FIG. 5 after selecting a document box 42 named “rush jobs” (See FIG. 4). In this case, three digital data files 51-53 are present in the selected document box 42. Data of each digital data file 51-53 may be shown in the third window 50 such as a file name, a name of a submitter, a number of pages of the file, a number of sets to be printed, a date and time indication of submission of the file, an estimated duration of the file to be printed and properties of a medium to be used to print the file.

Each digital data file 51-53 present in the shown selected document box 42 may be selected by touching the corresponding areas in which the digital data files 51-53 are displayed. According to the third window 50, two digital data files 51-52 are selected indicated by the grayed rectangles. A selected digital data file may be unselected by touching the selected digital data file again.

The third window 50 also comprises a number of action button items 54-56, 58 and 59. A first action button item 54 is shown in FIG. 5 as dashed, indicating that this item 54 is disabled at this moment, since more than one digital data file 51-52 is selected. The first action button item 54 will be enabled when one digital data file is selected.

In case of the selection of one digital data file 51, the first action button item 54 may be activated and shows, after activation, a set of properties of the selected digital data file 51.

A second action button item 55 may be activated in order to delete a selected digital data file.

A third action button item 56 may be activated in order to lock the settings of one or more selected digital data files. The settings are locked after activating the third action button item 56. The managing device 23 (See FIG. 2) determines which settings are going to be locked by checking a system setting of the reproduction apparatus, which system setting has registered which settings of a digital data file are allowed to be locked or not.

A fourth action button item 58 may be activated in order to create a first print of a selected digital data file. For a first print, a number of copies may be set to 1.

A fifth action button item 59 may be activated in order to print (additional) prints of a selected digital data file.

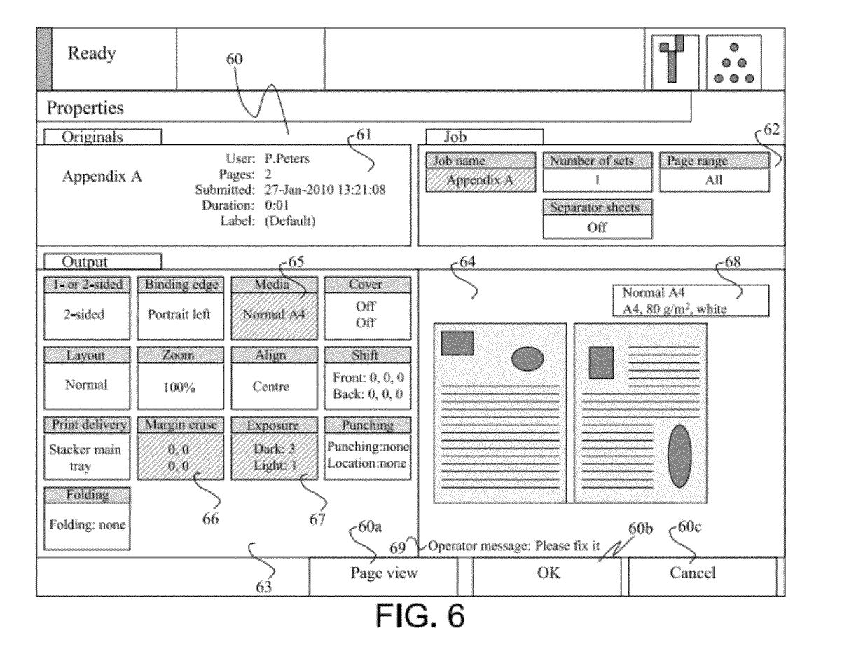

If the first action button item 54 is activated after selection of a digital data file 51 on the third window 50, a fourth window 60 is shown on top of, beside or instead of the third window 50. The fourth window 60 comprises a set of properties of the selected digital data file 51. Such a fourth window 60 is shown in FIG. 6.

Data belonging to the original data file is shown in a first area 61, for example a file name, a user name, a number of pages of the data file, a submission date and time, an estimated duration and a file label.

Job related data is shown in a second area 62, for example a job name, a number of sets, a page range and the possibility for using separator sheets.

Settings of the output are shown in a third area 63, for example 1- or 2-sided, binding edge, media, cover, layout, zoom factor, alignment, shift parameters, print delivery, margin erase, exposure, punching and folding. Each setting may be changed except the settings 65-67 that are grayed out. Settings that are grayed out may be determined by the managing device 23 according to appropriate system settings of the reproduction apparatus.

A schematic preview of a printed data file is shown in a fourth area 64. Media specifications 68 and an operator message 69 may also be shown in the fourth area 64.

A bottom toolbar may show a page view button item 60a in order for viewing each individual page of the data file, an OK button item 60b in order to confirm changed settings and a cancel button item 60c in order to cancel the changes done on the fourth window 60.

The fourth window 60 shows settings belonging to a data file that is not locked.

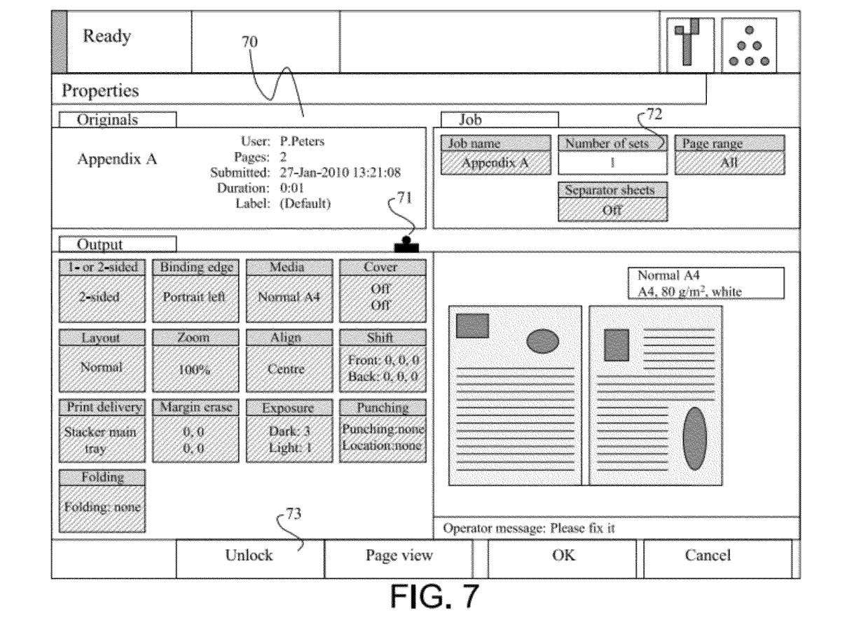

This is in contrast to a fifth window 70 in FIG. 7 which shows the same data file which is locked. The data file has been locked via the third action button item 56 on window 50. An additional lock symbol 71 shows that settings of the selected data file are locked. In this particular case, all settings of the selected data file are locked, except a setting 72 named “number of sets.” The locked settings have a dashed background to show that changing of the locked settings is disabled, while the unlocked setting 72 has a white background to show that changing of the unlocked setting 72 is enabled. Showing unchangeability/changeability of the settings by dashing is just schematically meant and may be shown in any other way on the user interface screen 25. The fifth window 70 also shows an unlock button item 73 for unlocking the locked settings of the digital data file. By showing this unlock button item 73 on the fifth window 70 and not on the third window 50, the user has to intentionally unlock the settings of one selected digital data file. This is advantageous with regard to unlocking, since this way of working may prevent the user from accidently making mistakes when unlocking settings.

So far, an action of locking and/or an action of unlocking takes place on a level of a data file via the third action button item 56 as shown on window 50 in FIG. 5. In an alternative embodiment also, a lock button item may be present on the fifth window 70—an unlock button item 73 is already present—in order to let an action of locking and/or an action of unlocking take place on a level of a setting of a data file instead of an action on the level of the data file. This is advantageous, since in that case it is possible to individually control the locking and unlocking of each setting.

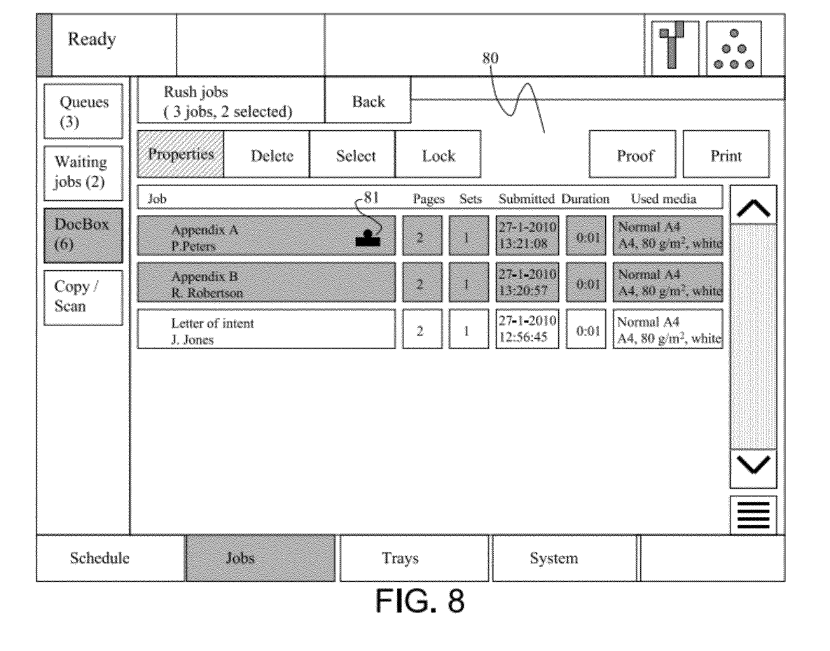

In a sixth window 80 according to FIG. 8, the same window is shown as the third window 50 in FIG. 5, except that the first data file is provided with a lock symbol 81 in order to show that at least one setting of the first data file is locked. In this way the user knows that at least one setting is locked without the need of opening the fourth window 60 shown in FIG. 6.

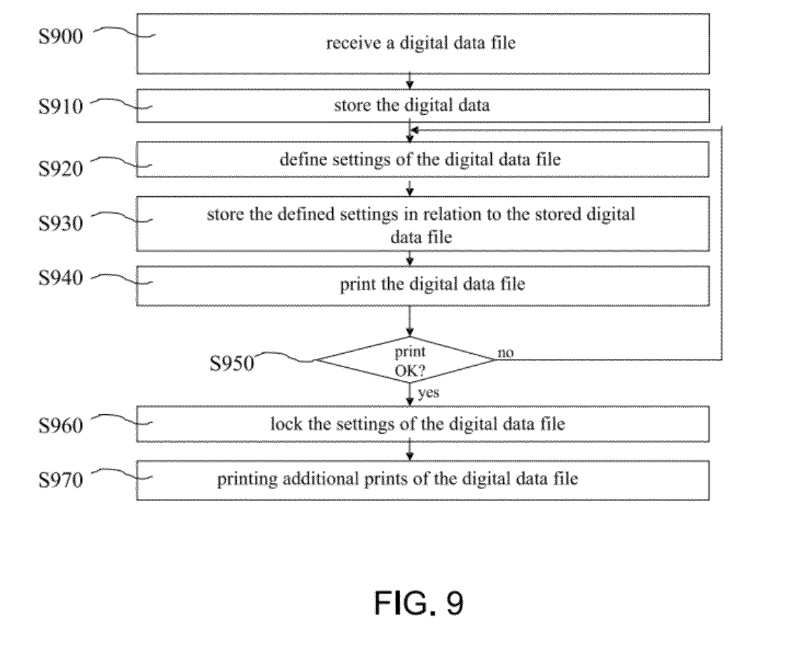

FIG. 9 shows an exemplary flow diagram of a method to be applied by the reproduction apparatus according to the invention. According to a first step S900, the reproduction apparatus receives a digital data file. This receiving may take place via the network to which the reproduction apparatus is connected or via a scan module of the reproduction apparatus. According to a second step S910, the received digital data file is stored in first storing device of the reproduction apparatus. According to a third step S920 settings of the digital data file are set by an operator via the user interface of the reproduction apparatus. According to a fourth step S930, the defined settings are stored in a second storing device of the reproduction apparatus via the local user interface by the operator. The stored settings are related to the corresponding stored digital data file, e.g. via a software coupling between the first and second storing devices. According to a fifth step S940, the digital data file is printed by the reproduction apparatus in order to obtain a correct print. According to a sixth step S950, it is checked if the print is correct. If not, the third step S920 is repeated. As long as the print is not correct according to the opinion of the user/operator, settings or other properties of the digital data file and/or the reproduction apparatus can be changed to obtain another print. When the print is perfect according to the opinion of the user/operator, the settings of the digital data file can be locked according to a seventh step S960, so as to prevent any inadvertent change of the settings. The operator locks the settings via the local user interface of the reproduction apparatus. The settings that are allowed be locked in the seventh step S960 are determined by system settings of the reproduction apparatus. After locking settings of the digital data file, additional prints, which number is determined by the user/operator, are printed by the reproduction apparatus according to an eighth step S970. It is noted that a substantial time period may have lapsed between the seventh step S960 and the eighth step S970. For example, the correct print may first be addressed to a customer in order to obtain his permission for the additional prints to be printed according to the correct print sent to the customer.

In an alternative embodiment of the method of the present invention, the seventh step S960 of locking the settings is performed before the fifth step S940 of printing the first print. This is especially advantageous if the job concerns a first print which has already been approved by the customer in an earlier print job. Such an earlier first print may be locked, since the first print and a corresponding number of additional prints were printed.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A digital image reproduction apparatus, comprising:
a receiving device configured to receive a print job comprising at least one digital data file;
a first storing device configured to store the print job;
a local user interface enabling an operator to make settings of the print job;
a managing device configured to manage settings of the print job
a second storing device configured to store the settings of the print job, which are related to the print job in the first storing device; and
a locking device, settable via the user interface, and configured to individually control the locking of at least one setting of the print job in order to achieve unchangeability of the at least one setting.

2. The digital image reproduction apparatus according to claim 1, wherein the locking device also enables unlocking of the at least one setting of the print job in order to achieve changeability of the at least one setting.

3. The digital image reproduction apparatus according to claim 1, wherein, for each digital data file in the print job, the locking device sets a flag representing one of statuses locked and unlocked, at least one setting of the digital data file is unchangeable when the status of the digital data file is locked, and at least one setting of the digital data file is changeable when the status of the digital data file is unlocked.

4. The digital image reproduction apparatus according to claim 3 wherein the local user interface is suitable to show simultaneously with the at least one selectable digital data file a lock item by activation of which the managing device writes the status locked at the flag corresponding to the at least one selected digital data file.

5. The digital image reproduction apparatus according to claim 3, wherein, after selection of a locked digital data file, the managing device shows on the local user interface simultaneously with settings of the selected locked digital data file an unlock item by activation of which the managing device writes the status unlocked at the flag corresponding to the locked digital data file.

6. The digital image reproduction apparatus according to claim 1, wherein the managing device is able to maintain a group of job settings which are excluded from locking.

7. The digital image reproduction apparatus according to claim 1, wherein a part of the settings of a digital data file are corresponding to system settings of the apparatus.

8. The digital image reproduction apparatus according to claim 3, wherein the managing device, when storing a digital data file in the storing device, writes one of the statuses at the flag corresponding to the digital data file, which status is indicated by a digital item included in the digital data file.

9. The digital image reproduction apparatus according to claim 3, wherein the local user interface is enabled to show a digital data file marked by a digital item indicating whether at least one setting of the digital data file is locked.

10. A method for printing a digital data file on a digital image reproduction apparatus comprising a local user interface, said method comprising the steps of:
receiving a digital data file by the digital image reproduction apparatus;
storing the digital data at the digital image reproduction apparatus;
defining settings of the digital data file by an operator via the local user interface;
storing the defined settings in relation to the stored digital data file by the operator via the local user interface;
printing the digital data file by the digital image reproduction apparatus; and
locking at least one setting of the digital data file by the operator via the local user interface so as to prevent any inadvertent change thereof.

11. The method according to claim 10, wherein the method further comprises the steps of:
unlocking the settings of the digital data file by the operator via the local user interface; and
changing the settings of the digital data file by the operator via the local user interface.
